(19) United States
(12) Patent Application Publication
(10) Pub. No.: US 2026/0170001 A1
(43) Pub. Date: Jun. 18, 2026

(54) RE-RANKING THE CONTEXT FOR MULTIMODAL RETRIEVAL AUGMENT GENERATION

(71) Applicant: NEC Laboratories America, Inc., Princeton, NJ (US)

(72) Inventors: Mohammad Khojastepour, Lawrenceville, NJ (US); Srimat Chakradhar, Manalapan, NJ (US); Matin Mortaheb, College Park, MD (US)

(21) Appl. No.: 19/423,132

(22) Filed: Dec. 17, 2025

Related U.S. Application Data
(60) Provisional application No. 63/734,780, filed on Dec. 17, 2024.

(51) Int. Cl. G06F 16/248; G06F 16/28; G06N 20/00

(52) U.S. Cl. CPC G06F 16/248; G06F 16/285; G06N 20/00

(57) ABSTRACT

Systems and methods for re-ranking in retrieval augment generation. The systems and methods include evaluating a relevancy in data in a retrieval augmented generation (RAG) database for a top-l preliminary number of results using cosine similarity, the relevancy being related to a query and filtering the top-l preliminary number of results to a top-k final number of results meeting a threshold τ using a relevancy score. The systems and methods further include selecting the top-k final number of results for response in an artificial intelligence (AI) model and generating a response in the AI model with the top-k final number of results with a highest relevancy score.

### RELATED APPLICATION INFORMATION

This application claims priority to U.S. Provisional Patent App. No. 63/734,780, filed on Dec. 17, 2024, incorporated herein by reference in its entirety.

### BACKGROUND

### Technical Field

The present invention relates to reducing irrelevant selection of entries to user selections in large language models and more particularly applying re-ranking in retrieval augmented generation result relevance.

### Description of the Related Art

One problem related to artificial intelligence (AI) is that irrelevant entries to user queries (e.g., incorrect or irrelevant documents or images) are sometimes selected. A common approach for solving irrelevant entry selection is retrieval augmented generation (RAG), in which a top-k results are selected by first ranking the entries from the knowledge-base based on a similarity scores between their embeddings and the user query and then selecting the top-k entries. One limitation of RAG is the tendency to assign high similarity scores to visually or semantically generic content, even when the result is irrelevant to the query. This inability to effectively filter out irrelevant data can lead to suboptimal retrieval and, consequently, hallucinations in downstream tasks.

### SUMMARY

According to an aspect of the present invention, a method is provided for re-ranking the context for multimodal retrieval augment generation. The method includes evaluating a relevancy in data in a retrieval augmented generation (RAG) database for a top-l preliminary number of results using cosine similarity, the relevancy being related to a query and filtering the top-l preliminary number of results to a top-k final number of results meeting a threshold τ using a relevancy score. The method further includes selecting the top-k final number of results for response in an artificial intelligence (AI) model and generating a response in the AI model with the top-k final number of results with a highest relevancy score.

According to another aspect of the present invention, a system is provided for a processor and a memory storing computer-readable instructions. The memory causes the processor to evaluate a relevancy in data in a retrieval augmented generation (RAG) database for a top-l preliminary number of results using cosine similarity, the relevancy being related to a query and filter the top-l preliminary number of results to a top-k final number of results meeting a threshold τ using a relevancy score. The memory further causes the processor to select the top-k final number of results for response in an artificial intelligence (AI) model and generate a response in the AI model with the top-k final number of results with a highest relevancy score.

According to yet another aspect of the present invention, a computer program product comprising a non-transitory computer-readable storage medium containing computer program code, the computer program code when executed by one or more processors causes the one or more processors to perform operations. The operations include causing the processors to evaluate a relevancy in data in a retrieval augmented generation (RAG) database for a top-l preliminary number of results using cosine similarity, the relevancy being related to a query and filter the top-l preliminary number of results to a top-k final number of results meeting a threshold τ using a relevancy score. The operations further include causing the one or more processors to select the top-k final number of results for response in an artificial intelligence (AI) model and generate a response in the AI model with the top-k final number of results with a highest relevancy score.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block diagram illustrating a high-level system for a multi-modal RAG AI model, in accordance with an embodiment of the present invention;

FIG. 2 is a block diagram of the multi-modal RAG AI model illustrated in greater detail, in accordance with an embodiment of the present invention;

FIG. 3 is a block diagram of a RAG AI model output evaluator, in accordance with an embodiment of the present invention;

FIG. 4 is a block diagram for generating a relevancy score of the RAG AI model output, in accordance with an embodiment of the present invention;

FIG. 5 is a block diagram for checking the RAG AI model output, in accordance with an embodiment of the present invention;

FIG. 6 is a block diagram illustrating the multi-modal RAG performing re-ranking, in accordance with an embodiment of the present invention;

FIG. 7 is a flow diagram for determining the relevance and correctness of the RAG AI model output, in accordance with an embodiment of the present invention; and

FIG. 8 is a block diagram illustrating a computer environment for determining the RAG AI model output relevance and correctness, in accordance with an embodiment of the present invention.

### DETAILED DESCRIPTION OF PREFERRED EMBODIMENTS

Embodiments of the present invention re-rank results from a retrieval augmented generation (RAG) model to increase the utility and trust of the model by evaluating and then re-evaluating the relevance of the entries before passing them to the response generation phase of an artificial intelligence (AI) model. The selection process of RAG includes a scoring function that can be used as a proxy or otherwise estimate relevance between an entry from the retrieval database and an input. An example of such a scoring function is a dot product between the two embedding vectors, one being a database entry and another being the input (e.g., query). Embodiments of the present invention include a scoring function and performing the selection of entries for response generation. A subset of entries can be formed from the database by using the dot product, then within the subset, perform a re-ranking of the entries by using a secondary scoring function. The most relevant entries after the re-ranking can then be selected.

RAG systems improve artificial intelligence (AI) models responses (particularly Large Language Models (LLMs)) by integrating external knowledge sources on which a user intends the responses to be based. In RAG systems, external knowledge such as enterprise data is stored in a database. When the user submits a query, the RAG system retrieves a several relevant and similar pieces of data from the database. The LLM then generates a response based on this information. This approach reduces irrelevant selections by constraining the LLM to generate responses grounded in the provided external knowledge, thereby increasing accuracy and relevance.

Some RAG systems work by selecting k entries from the database that have the highest similarity to a user query (e.g., top-k approach). A common approach is to select the k entries whose embeddings have the highest cosine similarity to the query embedding, referred to as the top-k entries. However, this method of selection does not always retrieve the most relevant data for the user query. The wrong selection can result in an incorrect response since the LLM is not otherwise aware of the correct information. Embodiments of the present invention re-rank retrieved entries in multimodal RAG systems to avoid the problems with irrelevant selections and penalize the model for results that are irrelevant.

In embodiments of the present invention, a neural network structure is designed and trained to generate a relevancy score from selected pieces of data from the RAG scheme. This can be done by applying the internal components of a RAG system and producing a relevancy score between each selected piece and the query. For example, when an image (or text) is selected, a relevancy score evaluates how relevant the retrieved image (or text) is to the user query. By assigning a relevancy score to each image, a determination can be made as to how well the visual data aligns with the intent of the user and the specific information requested. Embodiments of the present invention can penalize irrelevant entries when assessing query-specific relevance using re-ranking. While images are depicted in the figures, other types of data such as audio, video, code, etc., are also contemplated.

For example, given the query “a doctor holding a medical instrument,” the re-ranking relevancy score can prioritize images depicting this context over generic depictions of medical professionals or medical tools.

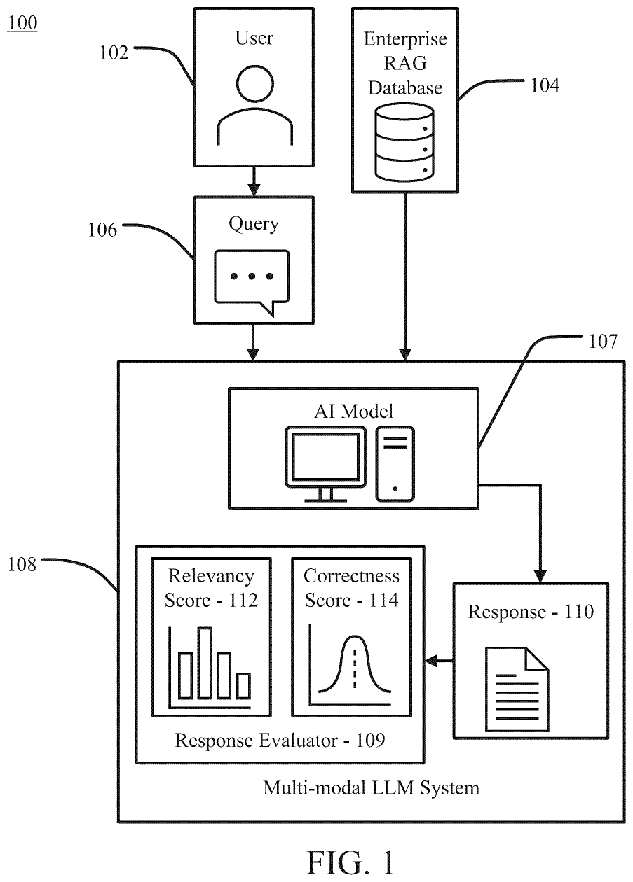

Referring now in detail to the figures in which like numerals represent the same or similar elements and initially to FIG. 1, a high-level block diagram for a multi-modal RAG is illustrated. A user 102 supplies a query 106 to a multi-modal LLM system 108. Multi-modal LLM system 108 can include AI model 107. AI model 107 can also be a generative or analytical AI model. AI model 107 can include text models such as, e.g., RAG framework 100, but can also be a visual language model (VLM), or include other types of data such as audio files, video, speech, code, time series data, tabular data, three dimensional data (e.g., computer aided design (CAD) files), haptic data, gestures, or a fusion of sensors to be a multi-model LLM, etc. Other types of data are also contemplated.

In an embodiment of the present invention, multi-modal LLM system 108 can reduce irrelevant selections of AI model 107 using RAG methodologies. Multi-modal LLM system 108 can evaluate query (e.g., an input) 106. AI model 107 can receive query 106 to derive (e.g., generate) a response 110, which can be an image, sound, text passage, etc. Multi-modal LLM system 108 can use an enterprise RAG database 104 to add contextual information to query 106 to reduce and/or eliminate irrelevant selections.

Multi-modal LLM system 108 can evaluate response 110 based on enterprise RAG database 104 and query 106 to determine a relevancy score 112 and a correctness score 114. Relevancy score 112 can determine (e.g. evaluate) the performance of the selection process of response 110 in response evaluator 109. Relevancy score 112 can provide the quantitative measure between zero (least relevant) and one (most relevant) for each retrieved piece of information from enterprise RAG database 104. Response 110 can be broken down into smaller pieces to assess the relevancy of each to query 106 more granularly. In some embodiments of the present invention, those pieces of information can be broken down several times until the information meets a certain criterion to improve the efficacy of RAG framework 100. The breakdown of the text response of the LLM is based on paragraphs, sentences, or phrases. In some cases, a sentence may also be broken down into two or more independent sentences.

Correctness score 114 determines performance of the generation process of response 110. Response 110 is broken down into smaller pieces, namely spans, and uses the spans to calculate correctness score 114 for a portion of response 110 in response evaluator 109 along with relevancy score 112. The spans can be categorized as either subjective (e.g., opinion; debatable; vague; unclear; human feelings; subject to personal viewpoints, experiences, or perspectives, etc.) or objective (e.g., factual, certain, clear, undeniable, etc.).

Enterprise RAG database 104 can include enterprise data, such as proprietary information, client information, company calculated information, or otherwise publicly unknown information. Alternatively, the information in enterprise RAG database 104 can include supplemental information that is known publicly but has not been incorporated into AI model 107. In further embodiments of the present invention, enterprise RAG database 104 can include information on the internet or other sources that can supplement AI model 107 until there is a new update on the model with additional training data or model weights. In other words, enterprise RAG database 104 can assist AI model 107 to specialize for a given purpose or add utility and not be specialized depending on the context and configuration. In other embodiments of the present invention, enterprise RAG database 104 can be used by individuals rather than business entities. User 102 can also customize enterprise RAG database 104 by adding personal information or other non-publicly known information. The enterprise RAG database can hold policies, operation records, technical reports, reports of internal activities such as summits, meetings, conferences, etc.

Enterprise RAG database 104 can be pre-processed by partitioning the data into pieces and generating embeddings for each piece of data. The pre-processing can apply to static or quasi-static enterprise data. When the enterprise data includes time varying or dynamic data, a specialized scheme can be used to reduce the overhead of such pre-processing in generation of the embeddings. For example, based on a query, part of the unprocessed enterprise data can be selected for processing.

The use of embeddings can serve a number of purposes. For example, the embeddings can form a compact representation of each piece of information to enhance the retrieval process for multi-modal LLM system 108. Embeddings are preferred over text-based searches between data and queries, even for text data that is not lengthy. Though both embeddings and text-based methods are possible and contemplated.

In RAG framework 100, depending on the type of data, embeddings can be derived via corresponding encoders. The embedding can have the same embedding space in order to facilitate searching. In an embodiment of the present invention, the relevancy score model can apply a dataset of an image and a pair of positive and negative statements. A dataset of both positive and negative statement ensures that the relevancy score model captures not only the general semantic alignment but also fine-grained contextual relevance/irrelevance.

To compute relevancy score 112, the relevancy score model takes query 106 and an entry (e.g., an image or text) as an input and produces a scalar score between 0 and 1 as an output. The higher the score, the higher the relevancy, i.e., a score of 1 is the highest relevancy and a score of 0 is the ultimate irrelevancy (completely irrelevant). Relevancy score 112 is normalized by using a sigmoid activation function at the last layer of the fine-tuned head. During training, the relevancy score model minimizes a modified version of reinforcement learning with a human feedback (RLHF) loss function that penalizes mismatched query-context pairs while rewarding alignment with the most relevant entries. This enables the relevancy score model to differentiate between relevant data and entries that might exhibit superficial similarity to the query.

Relevancy score 112 can be integrated with re-ranking by filtering the options to be evaluated with relevancy score 112 before they are actually evaluated. Re-ranking can occur any number of times. In other words, the filtering can happen once, twice, three times, etc. Each time the thresholds can be higher than the previous ranking, higher then lower, lower than higher, etc. The threshold can also be directed towards different aspects of the criteria to filter in multiples ways. For example, a prompt of a “show me a yellow dog” can filter for dogs and other canines like wolves, foxes, and cayotes, dingoes, etc. over other animals or yellow objects. Then, another filter can be for dogs instead of other types of canines. Even further filters can be for the color yellow such as yellow fur (e.g., yellow labrador retrievers and golden retrievers, etc.), instead of a husky in a yellow raincoat, a dalmatian covered in a yellow pollen, etc.

The threshold can be used on the value obtained by a contrastive language-image pre-trained (CLIP)-score in order to make a binary classification of the statements as relevant/irrelevant as related to query 106. Based on this binary classification, relevant entries can be passed on, while entries that are irrelevant can be penalized for further AI model 107 refinement. The penalization can be in the form of reinforcement learning or direct training. The penalization can be binary or non-binary. The non-binary penalization can be linear, quadratic, piecewise, log, etc. The penalization can aid the model in identifying the most relevant results.

Relevancy score 112 can incorporate re-ranking a top-k results, which includes retrieving a larger candidate set of size l, where l>k, using a CLIP dot product. These l candidates are then re-ranked based on relevancy score 112, which evaluates the query specific relevance of each candidate with higher precision. The top-k entries from the re-ranked list are selected as the final retrieved set for the RAG system. To further improve the quality of the selection, an adaptive mechanism that selects up to k candidates based on a threshold τ. Instead of selecting k images every time, this ensures that candidates with relevancy score 112 above τ are included.

For example, consider a query such as “a surgeon performing heart surgery.” If one image in the retrieved set is highly relevant, selecting k=5 images would force the inclusion of four irrelevant images, potentially introducing hallucinations into the generated response. By applying the threshold τ, the system dynamically adjusts the number of selected entries, including those that meet the relevance criterion. This adaptive re-ranking improves the alignment of retrieved entries with the user query and reduces the likelihood of irrelevant data causing hallucinations in downstream tasks. By combining the efficiency of CLIP for initial retrieval with the precision of relevancy score 112 for re-ranking, embodiments of the present invention achieve a balance between computational feasibility and retrieval quality, significantly enhancing the overall performance of multi-modal RAG systems. After penalization, the results can be stored and trained on to develop more relevant results in future queries. The training can be to avoid each of the initial top results that were not selected, or to seek words that were selected in the initial top results.

Enterprise RAG database 104 can include pairs of embeddings and references to which each piece of information that the embedding is derived from. Multi-modal LLM system 108 can select and generate information. A selection block retrieves the relevant pieces of information from enterprise RAG database 104. The selection process can be enhanced both in overhead and performance by using a hierarchical vector database and knowledge graph. The additional information in the structure of hierarchical vector databases and knowledge graph in comparison to plain vector database can be the source of enhancements in selection processes.

The selection process can determine the retrieved context which is comprised of the corresponding original pieces of data for the top-k entries in terms of the cosine similarity. The selection process can be evaluated by relevancy score 112 (e.g., how relevant the retrieved documents are). Relevancy score 112 can be used to directly perform the selection process instead of using cosine similarity.

A generation block which takes the retrieved context and generates response 110 based on the query 106 in AI model 107. In alternative embodiments of the present invention, the generation block can include engines that generate a text-based context for each piece of retrieved data, which is then collectively used as input to a LLM to generate response 110. In other words, response 110 can be generated from query 106 together with the pieces of retrieved data from enterprise RAG database 104 which are used in AI model 107 to generate response 110. The generation process can be evaluated by correctness score 114 (e.g., which parts of response 110 are supported by the RAG context).

Multi-modal LLM system 108 can provide feedback to user 102 such as indicating the relevancy score 112 and correctness score 114. Additionally, multi-modal LLM system 108 can recommend how to improve query 106 or otherwise receive a better response 110 such as including more precise or technical jargon to a question, wording query 106 to be less vague, add more specific direction to query 106, etc. Multi-modal LLM system 108 can also automatically modify query 106 to offer several alternative queries 106 that are associated with responses 110 with improved relevancy scores 112 and correctness scores 114.

These alternatives can be visualized, heard through a text-to-speech program, or otherwise conveyed to user 102. Multi-modal LLM system 108 can also record patterns in queries 106 made and suggest improvements to enterprise RAG database 104 and AI model 107 accordingly. For example, if many of the queries 106 entered into AI model 107 are directed towards visual question answering (VQA) on birds and other flying objects, multi-modal LLM system 108 can note of the pattern and recommend that additional ornithology and entomology information be included in the future.

The patterns can be noticed through AI or conventional computing (computing without AI). The AI included can be an artificial neural network (ANN) such as RNNs, CNNs, generative adversarial network (GAN), transformers, etc. Other methods can include descriptive statistics, hypothesis tests, regression analysis, time series analysis, control charts, decision trees, support vector machines, logistic regression, clustering, dimensionality reduction, association rule mining, semi-supervised learning, reinforcement learning, rule-based systems (e.g., if-then rules, regular expressions, signatures), proximity-based methods, visual graph representations, graph-based pattern detection, etc.

Embodiments of the present disclosure reflect VLM models as AI model 107 however, this is for demonstration purposes, other types of data can be used without visual or text data, or in addition to visual and text data.

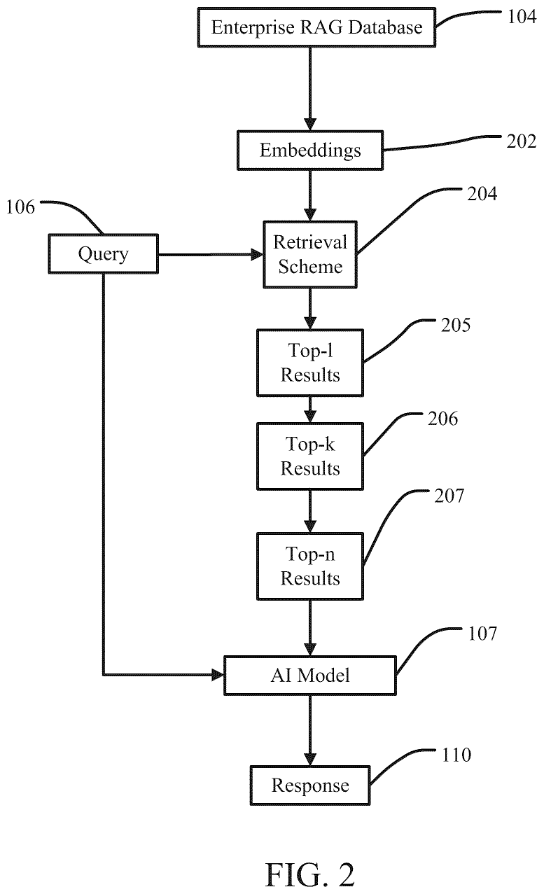

Referring to FIG. 2, a block diagram for the multi-modal RAG is illustrated in greater detail. Enterprise RAG database 104 can include image, text, video, audio, CAD and other three-dimensional data, and other types of data. The data within enterprise RAG database 104 can be embedded to form embeddings 202, which are used in retrieval scheme 204. Retrieval scheme 204 applies the RAG to provide top-k results 206.

A re-ranking can occur to retrieve a larger candidate set of size l, where l>k. The top-l results 205 (candidates) are then re-ranked based on relevancy score 112, which evaluate the query specific relevance of each candidate with higher precision. The value of number of entries k and l in the selection process can be based on the use case, historical data and prior observations for the same use case, or other methodologies. Top-k results 206 are re-ranked as the final retrieved set for the RAG system. A threshold τ can be implemented to adaptively change the value of k such that the score cannot be outside the bounds of the threshold (e.g., above or below the threshold), rather than a static number of k results.

Employing a dynamic selection of entries can be useful in instances when the number of relevant entries for a query is limited. In such instances, if the maximum number entries are selected, then some of the selected entries can have low relevance to the query, if passed on to the response generation, the response can be irrelevant or incorrect. By allowing a dynamic number of entries (up to) to k selection, entries that have low relevancy can be filtered (prevented from being selected), e.g., by evaluating relevancy score 112 against a threshold (t). The top-k results are then evaluated with CLIP to determine a binary classification from the threshold of whether the results are relevant or not (e.g., irrelevant). When selecting the entries, ranking the entries based on relevancy score 112 is a means of coarsely filtering responses, the top-k results (entries) with the highest scores are then further considered (e.g., these can be finely filtered), and within these top-k results, results that have relevancy score 112 that is higher than a threshold are selected for the response generation phase.

The top-k results 206 can be filtered to form a top-n results 207, where k>n. In other words, the process for obtaining top-k results 206 can be repeated to obtain top-n results 207. Either cosine similarity or a threshold relevancy score can be used to select top-n results. The filtering to collect the top-l results 205 can be done through a first heuristic and the filtering from top-k results 206 can be done through a second heuristic. The first heuristic and second heuristic can be the same or different. In an embodiment of the present invention, such a multi-layer selection technique is realized by having a first scoring function (e.g., top-k) and second relevance scoring function (e.g., top-l) that use different filters on different features, e.g., when filtering images, one filters on the color while another focuses on shape.

In some embodiments of the present invention, the threshold τ can be adaptive as well. Adapting the threshold can be done manually, or other means. The threshold can be adapted based on the total number of results received. For example, the threshold can increase (or decrease) to become more stringent on the relevancy with a larger (or smaller) number of top-l results. Alternatively, the threshold can be higher for more results that are relevant (e.g., have a higher relevancy score 112). Re-ranking can include cascade re-ranking, selective re-ranking, batch aware re-ranking, etc. In an embodiment of the present invention, the re-ranking can be nested or cascaded where a first subset of entries from the database is selected based on a first score and subsequently a second subset is selected from the first subset based on a second score, etc. In another embodiment of the present invention, selective re-ranking can be performed where filters are applied to each entry before calculation of the score. Examples of such filters include, e.g., a filter which selects a particular portion of the data or image, such as, e.g., a region of interest, a filter which selects specific colors in an image, or a filter that performs a masking or modification to the image such as blurring or sharpening particular part of the image. In yet another embodiment of the present invention, batch aware re-ranking can be performed where the database is hierarchical, and selection is performed in different batches based on different relevancy scores. Batch aware re-ranking also can include adapting relevancy score 112 based on the types of entries in each batch. Once top-k results 206 are selected, a response can be generated in the AI model with a result that has a highest relevancy score 112 from top-k results 206. Alternative ways of selecting the result to generate a response from are also contemplated. Or a response can be made for all top-k results 206.

Relevancy score 112 can be determined for each selection of top-k results 206. Once relevancy score 112 is determined, response 110 is broken down into several spans. One span can be subjective, while two more are objective. The two objective spans are scored for correctness score 114. Depending on the type of span defined (phrase, atomic statement, sentence, or paragraph), response 110 is spilt into those spans.

Atomic statements as full sentences that are self-sufficient in expressing a meaning without the need to be evaluated along with another sentence or part of the original text. For example, in response 110 “in the image, the desk is red and shiny. It is made of wood that is decorated with nice inlays.” The second sentence in response 110, the personal pronoun “it” has to be replaced with “the desk” to make this statement self-sufficient without the need to be evaluated with the first statement.

The subjective spans are not scored. Subjective spans can be classified as statements that include modal verbs (e.g., “could,” “might”), opinion indicators (e.g., “believe,” “feel”), hedging phrases (e.g., “it seems,”), uncertain quantifiers (e.g., “some,” “many”), adverbs of frequency and degree (e.g., “often,” “usually”), judgmental adjectives (e.g., “important,” “useful”), conjectures (e.g., “it is possible that”), and comparisons or preferences (e.g., “better,” “prefer”).

Query 106 can be input into retrieval scheme 204 to provide information to determine the most appropriate top-k results 206. Additionally, query 106 can be input into AI model 107. AI model 107 can include both a VLM and an LLM. In other embodiments, other generative AI models can be included or can replace either the VLM or LLM.

Top-k results 206 are then fed into AI model 107. In some embodiments of the present invention, top-k results 206 are fed into the VLM which provides context for the LLM. RAG framework 100 (FIG. 1) receives query 106 along with the context to provide response 110. Retrieval scheme 204 and top-k results 206 can be considered a selection process while the VLM and LLM can be considered a context and generation process.

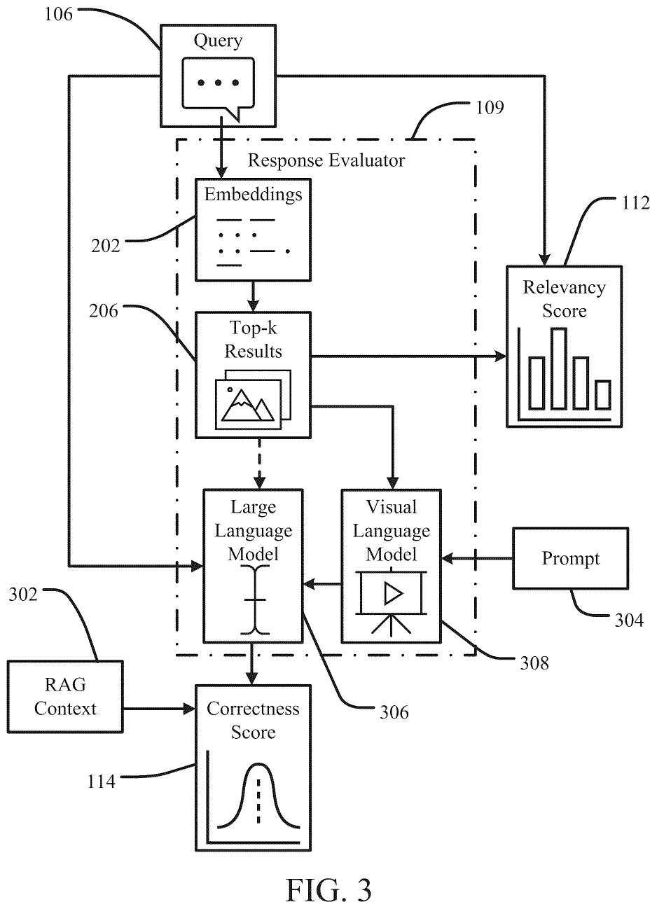

Referring to FIG. 3, response evaluator 109 is illustrated in greater detail. Query 106 is input into response evaluator 109 which performs the functions of a traditional RAG as well as additional capabilities including forming relevancy score 112 and correctness score 114. Query 106 is input into embeddings 202 to identify embedding vectors which select top-k results 206. Correctness score 114 can be determined based on top-k results 206. This means that correctness score 114 can be considered in the view of the top-k information that is provided to the generative process to produce the output. Hence, if incorrect information is given as a context, and the output reflects the same, then correctness score 114 is high and the output is considered correct in the view of the information that is provided. Top-k results 206 can also be input into VLM 308. Top-k results 206, in a non-limiting embodiment can be for 5 results. In alternative embodiments of the present invention the top-k results can be 10 results or any other number appropriate for the situation.

VLM 308 can also receive prompt 304. Prompt 304 can request VLM 308 to perform a task such as describing an image or VQA. Other types of prompt 304 are contemplated such as captioning, object recognition and localization, attribute recognition, activity or event recognition, scene understanding, sentiment analysis, image generation, image editing, visual storytelling, generation of variations, image search, text search within images, cross modal search, instruction following, environmental understanding, explain concepts visually, generate analogies, etc.

The result from VLM 308 can be input into LLM 306 along with query 106. Relevancy score 112 can be derived from the output of LLM 306. RAG context also is used in deriving relevancy score 112. Relevancy score 112 provides a measure of relevance between query 106 and each piece of RAG context 302 from the enterprise data. The relevancy in response evaluator 109 can be measured through cosine similarity between embeddings 202 in some embedding space. Embodiments of the present invention relate similarities between different data modalities and other measures can determine the similarity of embeddings 202. Relevancy score 112 can be designed to pretrain to different modalities such as images, video clips, audio clips, text, or varieties of the text file formats such as Portable Document Format (PDF) or PowerPoint slides where the text is in the form of images. The training for relevancy score 112 can also be performed on embeddings that represent different forms of the modalities such as CLIP embedding which maps both images and text into single embedding space.

Relevancy score 112 is obtained between query 106 and each piece of the RAG context 302 (e.g., an image) from enterprise RAG database 104 separately. Therefore, a model is designed and trained to receive an image and query 106 as an input and return a relevancy score 112 as a measure of the relevancy between an image and the query. Alternative embodiments of the present invention can use cross-attention between query 106 and the image in a transformer instead of cosine similarity.

Once the transformer module is designed properly, the output contains information about the relevancy between query 106 and the image. Then, a neural network head is trained to extract this information out of the produced embedding by the cross-attention module in the form of a single real number between zero (representing no relevance) and one (representing complete, total relevance).

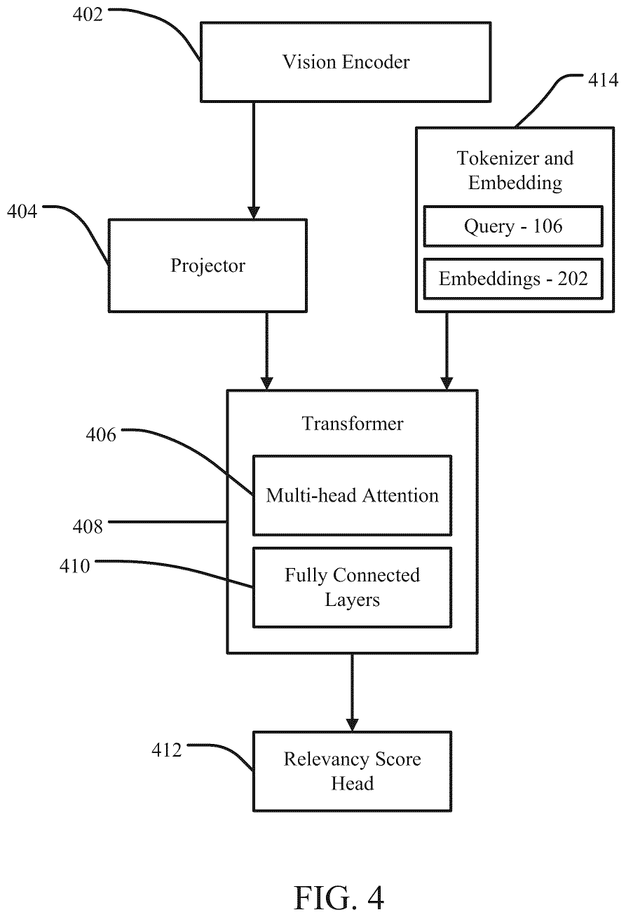

Referring to FIG. 4, a block diagram representing how to train for relevancy score 112 is illustrated. Vision encoder 402 encodes patches of images separately. In an embodiment of the present invention CLIP large can be used as vision encoder 402, which has a transformer architecture to encode image patches. This can also serve as a basis for comparison between the proposed relevancy score 112 and a score which is based on the cosine similarity between the pair of embeddings. While cosine similarity is show in the similarity between a pair of embeddings, it is also used as a measure of relevancy of an embedding to another embedding.

Projector 404 converts the embeddings to a form that transformer block 408 can apply. Tokenizer and embedder 414 tokenize text in accordance with text query 106 and maps the text to embedding 202. Some tokens can have special treatment. For example, if the query contains a special image token (<Image>), the token will be replaced with the embeddings of the patches. This means that both text and image can be translated to the internal language of the LLM in the form of the embedding. If there is no reference to an image, the system will add image embeddings 202 to the beginning of user query 106 embeddings 202. As a result in total, there are N+P embeddings 202 where N is the number of user query 106 tokens (with the exception of special tokens) and P is the total number of patches. The embedding 202 space is d dimensional, e.g., each embedding 202 has a dimension, d.

Transformer 408 includes multi-head attention 406 and fully connected layers 410. The entire N+P embeddings 202 are processed by transformer 408, which contains L transformer blocks each including multi-head attention 406 with H attention heads and fully-connected layers 410. Multi-head attention 406 can be used to find the relation between different patches of image and user query 106. The output of transformer 408 is a vector of N+P each with d dimension.

Relevancy score head 412 receives the last token generated from transformer 408, e.g., y_{N+P}. Relevancy score head 412 is a fully connected layer that maps dimension d to 1 which is trained to represent relevancy score 112 (FIG. 1).

Training the model from scratch to learn both language and the relationship between language and images uses significant amounts of data and computational power. Therefore, weights are leveraged from the current state-of-the-art model. This means that the weights are either randomly initialized or for faster convergence, the weights are initialized based on an available model and then trained. To train the relevancy score 112 model (specifically relevancy score head 412), a training dataset consisting of triplets ( [symbol] , sₚ, sₙ) is used, where [symbol] is the image, sₚ is a positive statement about the image [symbol] , and sₙ is a negative statement about the image [symbol] .

Relevancy score 112 model can be defined as [symbol] . The output of the model with the given statement s is a vector y= [symbol] ( [symbol] ; s) of dimension N+P. For the sake of brevity, y₋₁= [symbol] ( [symbol] ; s) represents the last output of the model given an image and a statement. In other words, y₋₁ is the input to relevancy score head 412. In some embodiments of the present invention, each query can include a template to state “Evaluate the relevancy of the given statement with the image <image>. Evaluate by either ‘relevant’ or ‘irrelevant.’ The statement is: s.”

Embodiments of the present invention use a modified version of a RLHF loss function to train relevancy score 112 model. In a generic RLHF model, even though there is data indicating both highly preferable and less preferable instances, the loss function only ensures that the highly preferable instance receives a higher score than the less preferable one, and there is no lower or upper bound of the loss function. Embodiments of the present invention modify RLHF such that a score is assigned that falls within the range of [0, 1] for any given statement and image. This is implemented by modifying the RLHF loss function to be [symbol] =log(σ(y₋₁( [symbol] , sₚ))−σ(y₋₁( [symbol] , sₙ))), where σ is the softmax operator. During the inference, given a pair of ( [symbol] , q), relevancy score 112 can be obtained as σ(y₋₁( [symbol] , q)). Using such modifications for RLHF allows for faster convergence of the model and better performance. This faster convergence of the model can improve a computer by reducing memory usage, reducing computing time, and computing resources, among other benefits.

Referring to correctness score 114, when the RAG response is generated, the response is partitioned into atomic statements to break the entire generated response into the spans. The atomic statements can be defined as

$${\{ {s}_{i} \}}_{i - 1}^{L} ,$$

where L is the number of spans. Each of the atomic statements are categorized and marked as subjective or objective. For objective statements, correctness score 114 models obtain are used. For each statement, the correctness score 114 model receives all retrieved images along with the statement for the correctness measure evaluation. The correctness factor takes a context (e.g., a set of images, or text, or both) and a span from the output text and provides correctness score 114 between the span of the output and the context.

Correctness score 114 model and relevancy score 112 model vary in their ability to work with multiple images rather than a single image (correctness score 114 being capable of working with multiple images while relevancy score 112 cannot).

The training process for the dedicated LM head used in the correctness score 114 model is similar relevancy score head 412. The initial template “I am giving you k images. Evaluate this statement with these images and answer by either ‘correct’ or ‘incorrect’: sᵢ.” When there is no reference to a piece of context, correctness score 114 is found between the statement and the entire retrieved context. However, in the calculation of correctness score 114 for a statement that has particular references to pieces of the context, correctness score 114 is found between the statement and the referred pieces of the context in the statement. In an embodiment of the present invention relevancy score 112 can be evaluated for a composite entry. A composite entry can include data and references to the data. When evaluating relevancy score 112 for a composite entry the reference is treated as a variable and can be replaced with the actual data before evaluation of the relevancy score. The reference, for example, can be to an image, another text, audio, etc.

For example, if an evaluation of the statement: sₖ=“A boy with a cowboy hat is riding a white house in <image1>,” correctness score 114 is computed by using the template: “I am giving you a statement. Evaluate this statement and answer by either ‘correct’ or ‘incorrect’: sₖ,” where the embeddings of image1 are inserted in the position of the token <image1>. Correctness score 114 can also be trained for the images and text input. Correctness score 114 is derived from a trained model.

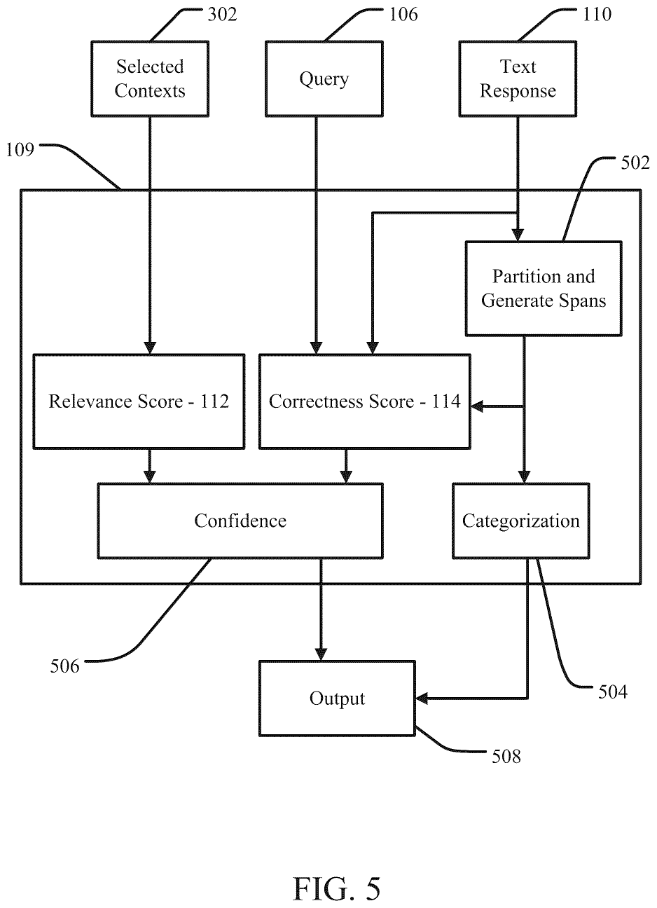

Referring to FIG. 5, a RAG checking program is illustrated in greater detail in accordance with an embodiment of the present invention. Response evaluator 109 evaluates various RAG systems in terms of their selection and generation performance using relevancy score 112 and correctness score 114. Response evaluator 109 receives RAG context 302, query 106, and response 110 as inputs. In some embodiments of the present invention RAG context 302 can be an image. In other embodiments of the present invention, other forms of data are contemplated. Query 106 is text based though any other form of natural language can also be contemplated such as videos of sign language, audio, etc. Response 110 is text based and can be generated using AI models like AI model 107 (FIG. 1).

Response evaluator 109 then determines relevancy score 112 and correctness score 114. Relevancy score 112 is derived from RAG context 302. Correctness score 114 is a result from query 106, response 110 and partition and generated spans 502 which are formed in response evaluator 109 from response 110.

Relevancy score 112 and correctness score 114 form confidence 506 which can be a confidence from response evaluator 109 that AI model 107 (FIG. 1) has a good response to query 106. The confidence score is a combination of relevance score and correctness score 114 and may be defined as multiplication of these two scores together. A good response can be relevant and correct. Response evaluator 109 can have response thresholds to trigger different actions based on confidence 506, which are different from the top-l/top-k threshold. For example, a high score (above a certain response threshold) can be sent to output 508 with categorization 504. Categorization 504 is derived from generated spans 502 and categorizes the spans as objective or subjective. This can allow user 102 (FIG. 1) to have a better understanding of the AI model processing. This can be especially helpful when AI model 107 (FIG. 1) is a black box model, though the information can be given in white box models.

Other confidence 506 values can lead response evaluator 109 to reevaluate RAG context 302 or response 110. Even further confidence 506 values below a second threshold can request that query 106 be entered again, as a means of potentially improving confidence 506. The confidence 506 can also be used to initiate a task, e.g., an online transaction, or to control a system.

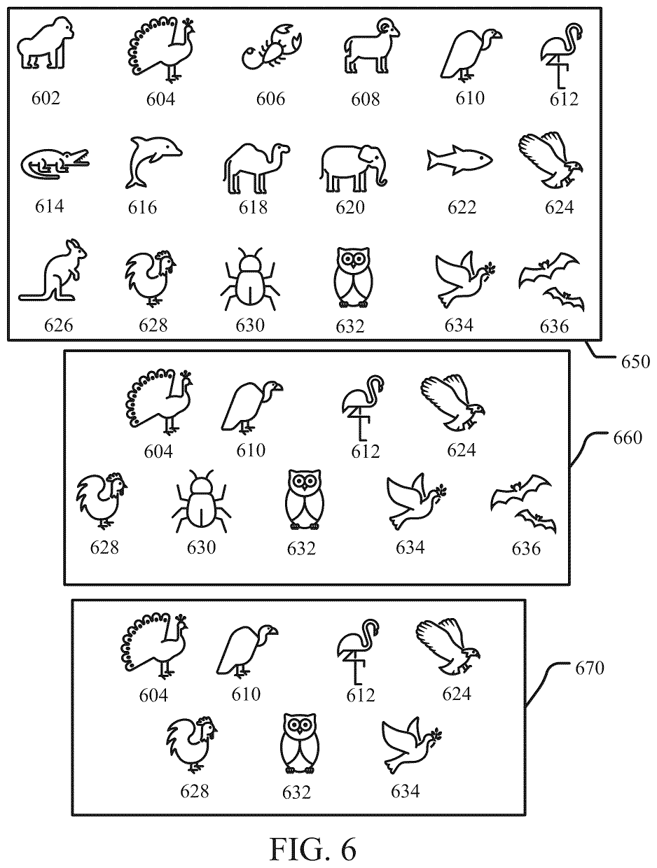

Referring to FIG. 6, a block diagram illustrating the re-ranking. The model can be tasked with identifying birds from a list. Initial list 650 can include gorilla 602, turkey 604, scorpion 606, goat 608, vulture 610, flamingo 612, crocodile 614, dolphin 616, camel 618, elephant 620, fish 622, eagle 624, kangaroo 626, chicken 628, beetle 630, owl 632, dove 634, and bats 636. The model can filter initial list 650 by relevance according to the heuristic “birds have wings.” Initial list 650 can be filtered to the top l results. To exemplify the re-ranking, let l=9. This means that the top-9 most relevant results will be selected at this first pass. Since roughly half the animals from initial list 650 have wings a higher threshold can be used to identify the birds, eliminating the non-winged animals. Since the number of animals with wings is low (˜50%), the average relevancy score 112 is low, and the threshold can be inversely related to the relevancy score.

Re-ranked list 660 removes the animals without wings, leaving turkey 604, vulture 610 flamingo 612, eagle 624, chicken 628, beetle 630, owl 632, dove 634, and bats 636. This top-l list eliminates half of the original list from initial list 650 and nearly accurate. Notably beetle 630 and bats 636 are still on the list because, while they are not birds, they do have wings. A re-ranking can be used to remove these remaining non-bird animals from the list. The top-k results can be selected, where k=7. Since most of the results are birds, and each has wings, the overall relevance is higher, and the threshold can be lower.

The model can now focus on other aspects of birds, for example the bone density of the remaining animals. Since beetle 630 do not have bones, they cannot make the top-k results. Since bats 636 are mammals, they do not have hallow bones but rather have solid bones and also do not make the top-k results. The remaining animals make final list 670, which includes turkey 604, vulture 610, flamingo 612, eagle 624, chicken 628, owl 632, and dove 634.

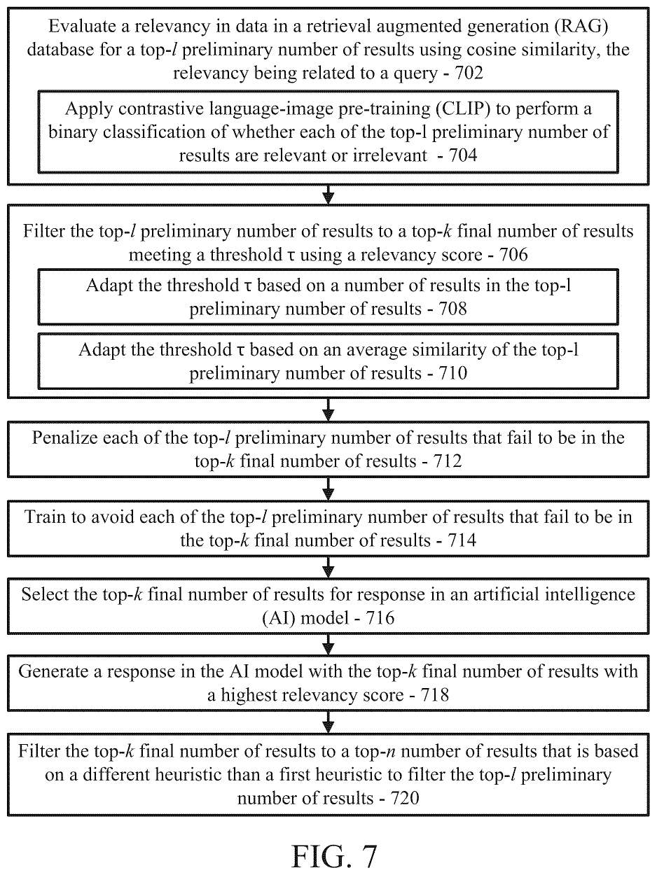

Referring to FIG. 7, a method for re-ranking the context for multimodal retrieval augment generation. In block 702, a relevancy in data in a retrieval augmented generation (RAG) database is evaluated for a top-l preliminary number of results using cosine similarity, the relevancy being related to a query.

In block 704, contrastive language-image pre-training (CLIP) is applied to perform a binary classification of whether each of the top-l preliminary number of results are relevant or irrelevant.

In block 706, the top-l preliminary number of results are filtered to a top-k final number of results meeting a threshold τ using a relevancy score. In block 708, the threshold τ is adapted based on a number of results in the top-l preliminary number of results. In block 710, the threshold τ is adapted based on an average similarity of the top-l preliminary number of results.

In block 712, each of the top-l preliminary number of results that fail to be in the top-k final number of results are penalized. In block 714, each of the top-l preliminary number of results that fail to be in the top-k final number of results are trained to be avoided. In block 716, the top-k final number of results are selected for response in an artificial intelligence (AI) model. In block 718, a response in the AI model is generated with the top-k final number of results with a highest relevancy score. In block 722, the top-k final number of results are filtered to a top-n number of results that is based on a different heuristic than a first heuristic to filter the top-l preliminary number of results.

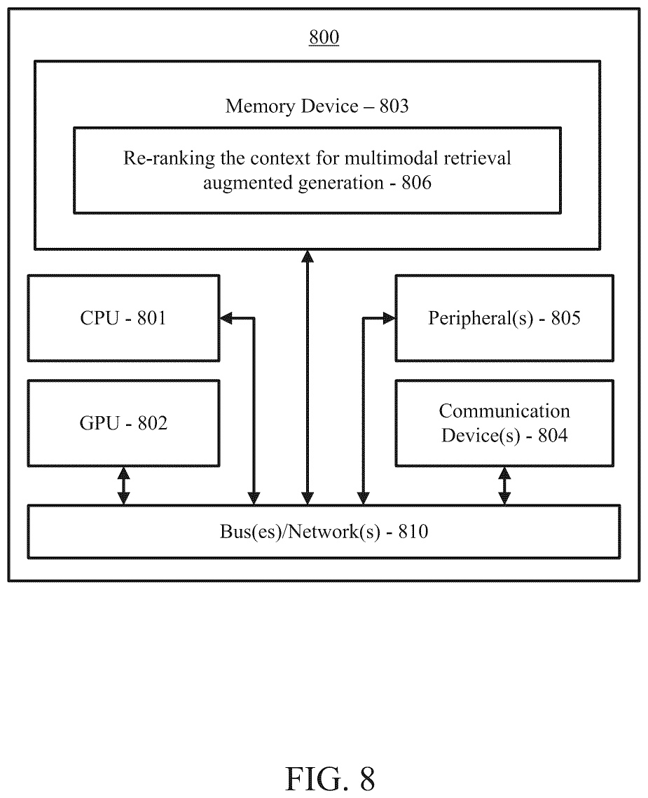

Referring to FIG. 8, a block diagram is shown for an exemplary processing system 800, in accordance with an embodiment of the present invention. The processing system 800 includes a set of processing units (e.g., CPUs) 701, a set of GPUs 802, a set of memory devices 803, a set of communication devices 804, and a set of peripherals 805. The CPUs 801 can be single or multi-core CPUs. The GPUs 802 can be single or multi-core GPUs. The one or more memory devices 803 can include caches, RAMs, ROMs, and other memories (flash, optical, magnetic, etc.). The communication devices 804 can include wireless and/or wired communication devices (e.g., network (e.g., Wi-Fi®, etc.) adapters, etc.). The peripherals 805 can include a display device, a user input device, a printer, an imaging device, and so forth. Elements of processing system 800 are connected by one or more buses or networks (collectively denoted by the figure reference numeral 710).

In an embodiment of the present invention, memory devices 803 can store specially programmed software modules to transform the computer processing system into a special purpose computer configured to implement various embodiments of the present invention. In an embodiment, special purpose hardware (e.g., Application Specific Integrated Circuits, Field Programmable Gate Arrays (FPGAs), and so forth) can be used to implement various embodiments of the present invention.

In an embodiment, memory devices 803 store program code or software 806 for evaluating multimodal RAG performance. The software 806 implements one or more functions of the systems and methods described herein for evaluating a relevancy in data in a retrieval augmented generation (RAG) database for a top-l preliminary number of results using cosine similarity, the relevancy being related to a query and filtering the top-l preliminary number of results to a top-k final number of results meeting a threshold τ using a relevancy score. Software 806 also includes selecting the top-k final number of results for response in an artificial intelligence (AI) model and generating a response in the AI model with the top-k final number of results with a highest relevancy score.

Of course, the processing system 800 may also include other elements (not shown), as readily contemplated by one of skill in the art, as well as omitting certain elements. For example, various other input devices and/or output devices can be included in processing system 800, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 800 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 800.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs). These and other variations of a hardware processor subsystem are also contemplated in accordance with embodiments of the present invention.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment,” as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method comprising:
evaluating a relevancy in data in a retrieval augmented generation (RAG) database for a top-l preliminary number of results using cosine similarity, the relevancy being related to a query;
filtering the top-l preliminary number of results to a top-k final number of results meeting a threshold τ using a relevancy score;
selecting the top-k final number of results for response in an artificial intelligence (AI) model; and
generating a response in the AI model with the top-k final number of results with a highest relevancy score.

2. The method of claim 1, further comprising:
penalizing each of the top-l preliminary number of results that fail to be in the top-k final number of results.

3. The method of claim 2, further comprising:
training to avoid each of the top-l preliminary number of results that fail to be in the top-k final number of results.

4. The method of claim 1, further comprising:
filtering the top-k final number of results to a top-n number of results that is based on a different heuristic than a first heuristic to filter the top-l preliminary number of results.

5. The method of claim 1, further comprising:
adapting the threshold τ based on a number of results in the top-l preliminary number of results.

6. The method of claim 1, further comprising:
adapting the threshold τ based on an average similarity of the top-l preliminary number of results.

7. The method of claim 1, further comprising:
applying contrastive language-image pre-training (CLIP) to perform a binary classification of whether each of the top-l preliminary number of results are relevant or irrelevant.

8. A system for evaluating multimodal retrieval augmented generation (RAG) performance, comprising:
a processor; and
a memory storing computer-readable instructions that, when executed by the processor, cause the processor to:
evaluate a relevancy in data in a retrieval augmented generation (RAG) database for a top-l preliminary number of results using cosine similarity, the relevancy being related to a query;
filter the top-l preliminary number of results to a top-k final number of results meeting a threshold τ using a relevancy score;
select the top-k final number of results for response in an artificial intelligence (AI) model; and
generate a response in the AI model with the top-k final number of results with a highest relevancy score.

9. The system of claim 8, wherein the memory further causes the processor to:
penalize each of the top-l preliminary number of results that fail to be in the top-k final number of results.

10. The system of claim 9, wherein the memory further causes the processor to:
train to avoid each of the top-l preliminary number of results that fail to be in the top-k final number of results.

11. The system of claim 8, wherein the memory further causes the processor to:
filter the top-k final number of results to a top-n number of results that is based on a different heuristic than a first heuristic to filter the top-l preliminary number of results.

12. The system of claim 8, wherein the memory further causes the processor to:
adapt the threshold τ based on a number of results in the top-l preliminary number of results.

13. The system of claim 8, wherein the memory further causes the processor to:
adapt the threshold τ based on an average similarity of the top-l preliminary number of results.

14. The system of claim 8, wherein the memory further causes the processor to:
apply contrastive language-image pre-training (CLIP) to perform a binary classification of whether each of the top-l preliminary number of results are relevant or irrelevant.

15. A computer program product comprising a non-transitory computer-readable storage medium containing computer program code, the computer program code when executed by one or more processors causes the one or more processors to perform operations, the computer program code comprising instructions to:
evaluate a relevancy in data in a retrieval augmented generation (RAG) database for a top-l preliminary number of results using cosine similarity, the relevancy being related to a query;
filter the top-l preliminary number of results to a top-k final number of results meeting a threshold τ using a relevancy score;
select the top-k final number of results for response in an artificial intelligence (AI) model; and
generate a response in the AI model with the top-k final number of results with a highest relevancy score.

16. The computer program code of claim 15, wherein the computer program code further includes instructions to:
penalize each of the top-l preliminary number of results that fail to be in the top-k final number of results.

17. The computer program code of claim 16, wherein the computer program code further includes instructions to:
train to avoid each of the top-l preliminary number of results that fail to be in the top-k final number of results.

18. The computer program code of claim 15, wherein the computer program code further includes instructions to:
filter the top-k final number of results to a top-n number of results that is based on a different heuristic than a first heuristic to filter the top-l preliminary number of results.

19. The computer program code of claim 15, wherein the computer program code further includes instructions to:
adapt the threshold τ based on a number of results in the top-l preliminary number of results.

20. The computer program code of claim 15, wherein the computer program code further includes instructions to:
adapt the threshold τ based on an average similarity of the top-l preliminary number of results.
